(19) United States
(12) Patent Application Publication
(10) Pub. No.: US 2025/0058312 A1
(43) Pub. Date: Feb. 20, 2025

(54) TRACE METER AND METHOD FOR CALIBRATING DYNAMIC ULTRA-MICRO PIPETTING DEVICE

(71) Applicant: NIMTT, Chengdu (CN)

(72) Inventors: Lihua Zhou, Chengdu (CN); Jiangwen Tang, Chengdu (CN); Chuandi Xu, Chengdu (CN); Zhanyue Jiang, Chengdu (CN)

(73) Assignee: NIMTT, Chengdu (CN)

(21) Appl. No.: 18/797,807

(22) Filed: Aug. 8, 2024

(30) Foreign Application Priority Data
Aug. 16, 2023 (CN) 202311027098.5
May 31, 2024 (WO) PCT/CN2024/096521

(51) Int. Cl. B01L 3/02

(52) U.S. Cl. CPC B01L 3/0213; B01L 2200/146; B01L 2200/147; B01L 2200/148; B01L 2300/123

(57) ABSTRACT

A trace meter and a method for calibrating a dynamic ultra-micro pipetting device are provided, which relate to the technical field of dynamic pipetting precision calibration. The trace meter includes a measuring compartment, a temperature sensor, a pressure sensor and a controller. A top of the measuring compartment is open, the temperature sensor is provided at a bottom of the measuring compartment, the pressure sensor is provided below the measuring compartment, both the temperature sensor and the pressure sensor are electrically connected with the controller, the temperature sensor is configured to measure the temperature of liquid in the measuring compartment, and the pressure sensor is configured to measure the weight of liquid in the measuring compartment.

### CROSS REFERENCE TO RELATED APPLICATION

This application is a national stage application of International Patent Application No. PCT/CN2024/096521, filed on May 31, 2024, which claims the priority of Chinese Patent Application No. 2023110270985 entitled “TRACE METER AND METHOD FOR CALIBRATING DYNAMIC ULTRA-MICRO PIPETTING DEVICE” filed with the Chinese Patent Office on Aug. 16, 2023, which is incorporated herein by reference in its entirety.

### TECHNICAL FIELD

The present disclosure relate to the technical field of dynamic pipetting precision calibration, and in particular to a trace meter and a method for calibrating a dynamic ultra-micro pipetting device.

### BACKGROUND

A dynamic pipetting device is an automatic pipetting workstation with high-throughput dynamic pipetting capacity, and is an automatic device which completes liquid handling operation such as pipetting through machine operation based on the principle of liquid displacement or gas displacement. The automatic pipetting workstation is an instrument mainly used in the fields of biology and clinical medicine, which is often used in the process of RNA purification, microRNA purification, viral nucleic acid purification, DNA/RNA recovery and protein purification, and is mainly responsible for the subpackaging and transfer of samples or reagents. The high-throughput dynamic pipetting device is often used for pretreatment of high-throughput sequencing. The high-throughput sequencing technology is also referred to as “Next-Generation Sequencing Technology” or “Large-scale Parallel Sequencing Technology”. Compared with the conventional dideoxy sequencing technology, the high-throughput sequencing technology can perform parallel serial determination on a large number of nucleic acid molecules at one time, and usually a sequencing reaction can produce sequencing data of no less than 100 Mb. Trace refers to a very small amount, which is only a little trace. In the field of applied science, the content of a substance below one millionth is referred to as trace, and trace can also be used in chemistry, material science, biomedicine, etc.

The dynamic pipetting device is a device of extracting and purifying components such as nucleic acid by transferring reaction solution, and usually includes multiple pipetting heads. A single pipetting head is configured to quantitatively absorb the transferred liquid, and the multiple pipetting heads are configured to extract the liquid with a high throughput.

In view of the above-mentioned related technologies, the applicant believes that in the related technologies, the pipetting precision of pipetting heads is affected due to human operation and environmental factors during long-term use. Especially when ultra-micro dynamic pipetting is performed, no accurate measurement is performed. A conventional measurement and calibration device cannot accurately measure and calibrate the ultra-micro dynamic pipetting precision, which leads to excessive differences among channels of the pipetting device, affects the measurement results of multiple samples, and is not convenient for the large-scale application of the pipetting device to small samples.

### SUMMARY

The embodiments aim to provide a trace meter and a method for calibrating a dynamic ultra-micro pipetting device, which facilitate the measurement and calibration of the ultra-micro dynamic pipetting precision of a high-throughput nucleic acid extraction device, so as to improve the metering precision of ultra-micro pipetting extracted by the high-throughput nucleic acid extraction device.

The present disclosure is achieved by the following technical solution.

The present disclosure provides a trace meter, including a measuring compartment, a temperature sensor, a pressure sensor and a controller. A top of the measuring compartment is open. The temperature sensor is provided at a bottom of the measuring compartment. The pressure sensor is provided below the measuring compartment. Both the temperature sensor and the pressure sensor are electrically connected with the controller. The temperature sensor is configured to measure a temperature of liquid in the measuring compartment. The pressure sensor is configured to measure a weight of the liquid in the measuring compartment.

Further, an inner bottom wall of the measuring compartment is provided with a lowest inclination point. The lowest inclination point is located directly below a center of gravity of the measuring compartment. A measuring hole is formed at the lowest inclination point of the bottom wall of the measuring compartment. One side, adjacent to an inside of the measuring compartment, of the measuring hole is covered with a flexible heat-conducting film. A sensing end of the temperature sensor is placed in the measuring hole and abuts against a lower surface of the flexible heat-conducting film.

Further, a steam shield covers above the measuring compartment, and a through hole is formed in the steam shield for a pipetting head to pass through.

Further, the trace meter further includes a bottom shell provided below the measuring compartment. The pressure sensor is provided in the bottom shell. The bottom shell is provided with a windshield. The windshield is configured to cover the measuring compartment. A dripping hole is formed in a top wall of the windshield for the pipetting head to pass through. A protective plate is provided above the windshield. A passage hole is formed in the protective plate. An aperture of the through hole and an aperture of the dripping hole are both larger than an aperture of the passage hole. A center line of the dripping hole, a center line of the through hole and a center line of the measuring hole are overlapped with each other. Gaps are left between the measuring compartment and the windshield and between the steam shield and the windshield, respectively.

Further, a weighing plate is provided below the measuring compartment. The pressure sensor is located below the weighing plate. A positioning groove is formed in the weighing plate. The positioning groove includes a concave conical surface and a horizontal inner bottom wall. An outer bottom wall of the measuring compartment is provided with a positioning portion. A shape of the positioning portion is matched with a shape of the positioning groove. The positioning portion is located in the positioning groove. The measuring hole of the measuring compartment is located directly above the horizontal inner bottom wall of the positioning groove.

The present disclosure further provides a method for calibrating a dynamic ultra-micro pipetting device, the method calibrates the dynamic ultra-micro pipetting device by using the trace meter, the method includes the following steps:
S1, moving a pipetting head to a target position;
S2, moving the trace meter to locate a dripping hole directly below the pipetting head;
S3, placing standard liquid at a position where liquid is to be taken;
S4, clearing measurement data of the trace meter to zero;
S5, operating a same pipetting head to dynamically pipet liquid into a measuring compartment for n times, and reading a temperature data and a weight data of the liquid after each pipetting, wherein n is total pipetting times in a single channel;
S6, obtaining n groups of measurement data of the dynamic pipetting process in the single channel, checking and correcting the measurement data, and calculating consistency of pipetting in the single channel by the controller;
S7, removing the standard liquid in the measuring compartment;
S8, repeating Step S1 to Step S7 to measure a next channel;
S9, after measuring all channels, calculating a total standard deviation of dynamic high-throughput pipetting.

Further, in the Step S6, the controller calculates a liquid volume in the measuring compartment, wherein the liquid volume is

$${V}_{x} = \frac{{m}_{x}}{1 + 3 \times {10}^{- 5} t - 6 \times {10}^{- 6} {t}^{2}} ,$$

Vₓ is the liquid volume after each pipetting in the single channel, mx is a mass of a measured liquid, and t is a temperature of the measured liquid

Further, in the Step S6, the controller corrects the liquid volume Vₓ, wherein a volume correction value is V_{c}=a+b×Vₓ, a measurement result of a corrected volume is V=V_{c}+Vₐ, V is a final measurement result of the liquid volume after current pipetting, and a and b are correction coefficients of periodic calibration management and are preset in the controller after being measured and calibrated by a calibration unit at an upper level.

Further, in the Step S6, the consistency of pipetting in the single channel is

$$γ = \sqrt{\frac{{\sum }_{i = 1}^{n} {( {V}_{i} - \frac{{\sum }_{i = 1}^{n} {V}_{i}}{n} )}^{2}}{n - 1}} ,$$

Vᵢ is a volume of i-th pipetting in a current channel, Vᵢ=V−Σᵢ₌₁⁽ⁱ⁻¹⁾>Vᵢ, wherein i=1, 2, 3, . . . , n.

Further, in the Step S9, the total standard deviation of the dynamic high-throughput pipetting is

$$σ = \sqrt{\frac{1}{n \times m} {\sum }_{j = 1}^{m} {\sum }_{i = 1}^{n} {( {V}_{ji} - \overline{V} )}^{2}} ,$$

Vᵢⱼ is the volume of the i-th pipetting in a j-th channel, i=1, 2, 3, . . . , n, j=1, 2, 3, . . . , m, m is a number of measured channels, and V̅ is a volume average of each pipetting,

$$\overline{V} = \frac{1}{n \times m} {\sum }_{j = 1}^{m} {\sum }_{i = 1}^{n} {V}_{ji} .$$

Compared with the prior art, the embodiments have the following advantages and beneficial effects.

1. The liquid is pipetted into the measuring compartment for many times through a single channel. The temperature, the mass and the volume of each pipetting are measured and calculated at the same time, so as to calculate the consistency of pipetting in the single channel and judge the metering precision in the single channel. The smaller the consistency of pipetting in the single channel, the higher the metering precision of pipetting in the single channel, otherwise, the lower the metering precision of pipetting in the single channel. The trace meter structure and the measuring method of the embodiments can reduce the evaporation loss of liquid in the pipetting measurement process, which is beneficial to improving the measurement precision of ultra-micro pipetting of the pipetting device. Thereafter, it is convenient to calibrate the dynamic ultra-micro pipetting precision of the pipetting device. The trace meter of the embodiments can directly output the volume value of high-precision pipetting, which is convenient to use.

2. The total standard deviation of high-throughput pipetting is calculated after performing pipetting measurements on all channels for many times, which is convenient to judge the overall pipetting precision of the high-throughput pipetting device. The smaller the total standard deviation, the higher the overall pipetting precision of the high-throughput pipetting device.

### BRIEF DESCRIPTION OF THE DRAWINGS

The drawings described herein are provided to provide a further understanding of the embodiments of the present disclosure and constitute a part of this application, and do not constitute limitations of the embodiments of the present disclosure.

In the figures:

FIG. 1 is a schematic structural diagram of Embodiment 1 of the present disclosure.

FIG. 2 is a partial structural cross-sectional view of Embodiment 1 of the present disclosure.

FIG. 3 is a circuit diagram of temperature acquisition of Embodiment 1 of the present disclosure.

FIG. 4 is a weighing circuit diagram of Embodiment 1 of the present disclosure.

Reference numerals in the drawings and names of corresponding parts:
1 measuring compartment; 2 temperature sensor; 3 pressure sensor; 4 controller; 5 measuring hole; 6 flexible heat-conducting film; 7 steam shield; 8 through hole; 9 bottom shell; 10 windshield; 11 dripping hole; 12 protective plate; 13 passage hole; 14 weighing plate; 15 positioning groove; 16 pipetting head; 17 upper computer; 18 analog-to-digital converter; 19 microcontroller unit; 20 external interface; 21 power module.

### DETAILED DESCRIPTION OF THE EMBODIMENTS

In order to make the purpose, the technical solution and the advantages of the present disclosure more clear, the present disclosure will be further described in detail in conjunction with embodiments and attached drawings. The illustrative embodiments of the present disclosure and their descriptions are only used for explaining the present disclosure, and are not used as limitations of the present disclosure. It should be noted that the present disclosure has been in the actual development and use stage.

### Embodiment 1

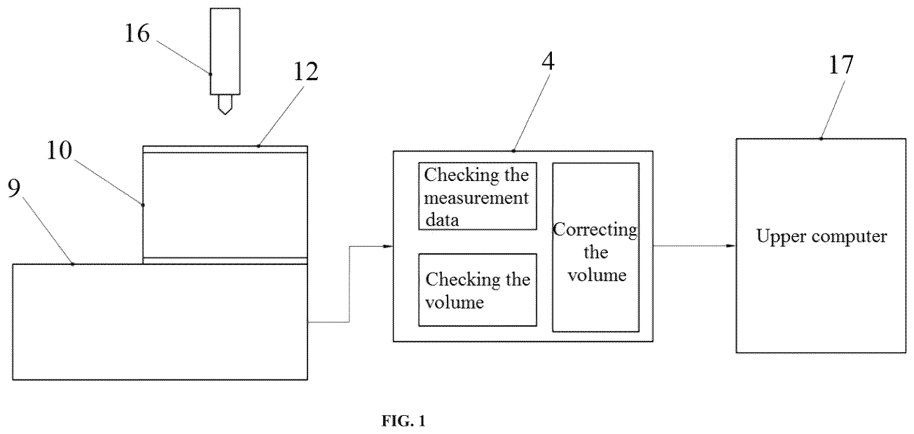

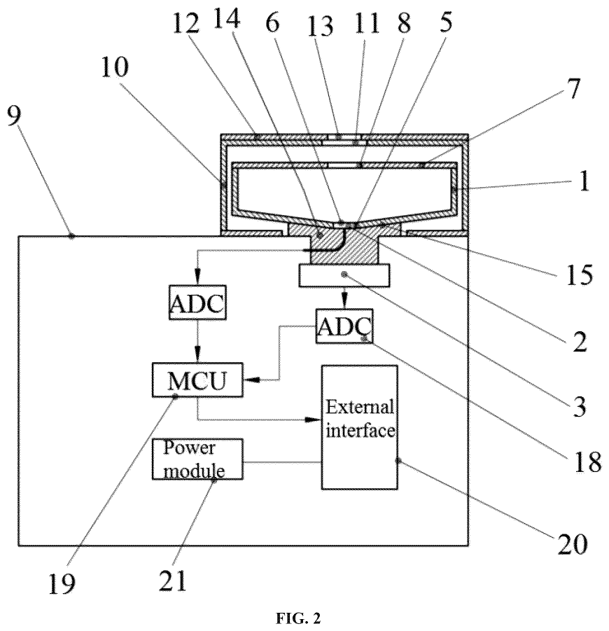

As shown in FIG. 1 and FIG. 2, the embodiment provides a trace meter, including a measuring compartment 1, a temperature sensor 2, a pressure sensor 3 and a controller 4. A top of the measuring compartment 1 is open. The temperature sensor 2 is provided at a bottom of the measuring compartment 1. The pressure sensor 3 is provided below the measuring compartment 1. Both the temperature sensor 2 and the pressure sensor 3 are electrically connected with the controller 4. The temperature sensor 2 is configured to measure the temperature of liquid in the measuring compartment 1. The pressure sensor 3 is configured to measure the weight of the liquid in the measuring compartment 1. The liquid is pipetted into the measuring compartment for many times through a single channel. The temperature, the mass and the volume of each pipetting are measured and calculated at the same time, so as to calculate the consistency of pipetting in the single channel by the controller 4 and judge the metering precision in the single channel. The smaller the consistency of pipetting in the single channel, the higher the metering precision of pipetting in the single channel, otherwise, the lower the metering precision of pipetting in the single channel. Further, the total standard deviation of high-throughput pipetting can be calculated, which is convenient to judge and calibrate the overall pipetting precision of the high-throughput pipetting device. The smaller the total standard deviation, the higher the overall pipetting precision of the high-throughput pipetting device.

As a preferred embodiment, as shown in FIG. 1 and FIG. 2, an inner bottom wall of the measuring compartment 1 is provided with an lowest inclination point. The inner bottom wall of the measuring compartment 1 is in a concave conical shape. The lowest inclination point is located directly below the center of gravity of the measuring compartment 1. A through measuring hole 5 is formed at the lowest inclination point of the bottom wall of the measuring compartment 1. One side, adjacent to an inside of the measuring compartment 1, of the measuring hole 5 is covered with a flexible heat-conducting film 6, and a sensing end of the temperature sensor 2 is placed in the measuring hole 5 and abuts against a lower surface of the flexible heat-conducting film 6 (the side, away from the inside of the measuring compartment 1, of the flexible heat-conducting film 6). After adding the liquid into the measuring compartment 1, the liquid is collected at the lowest point inside the measuring compartment 1, which is beneficial to maintaining the balance and stability of the measuring compartment 1. The temperature sensor 2 adopts a heat-sensitive temperature sensor, and the sensing portion of the temperature sensor 2 measures the liquid in the measuring compartment 1 through the flexible heat-conducting film 6, which has sensitive response and good stability.

As a preferred embodiment, as shown in FIG. 1 and FIG. 2, a steam shield 7 detachably covers above the measuring compartment 1. The steam shield 7 and the measuring compartment 1 are made of ultra-light materials with low thermal conductivity, such as aerogel materials, vacuum thermal insulation materials, graphite polystyrene materials and PFT thermal insulation materials. A through hole 8 is formed in the steam shield 7 for a pipetting head 16 to pass through. The pipetting head 16 is operated to extend into the measuring chamber 1 through the through hole 8 of the steam shield 7 to add liquid. The steam shield 7 is beneficial to reducing the evaporation loss of the liquid in the measuring chamber 1, which is especially significant for the precision measurement of ultra-micro pipetting.

As a preferred embodiment, as shown in FIG. 1 and FIG. 2, the trace meter further includes a bottom shell 9 provided below the measuring compartment 1. The pressure sensor 3 is provided in the bottom shell 9. The bottom shell 9 is provided with a windshield 10 through a fastener to facilitate the disassembly of the windshield 10. The windshield 10 is configured to cover the measuring compartment 1. A dripping hole 11 is formed in a top wall of the windshield 10 for the pipetting head 16 to pass through. Gaps are left between the measuring compartment 1 and the windshield 10 and between the steam shield 7 and the windshield 10, respectively. The windshield 10 is beneficial to reducing the shaking influence resulted from the flow of external air on the measuring compartment 1 and ensuring the precision of measuring the liquid weight by the measuring compartment 1. A protective plate 12 is provided on the outer top wall of the windshield 10 through fasteners. The protective plate 12 is used in cooperation with the steam shield 7. A passage hole 13 is formed in the protective plate 12 for the pipetting head 16 to pass through. The center line of the passage hole 13, the center line of the dripping hole 11, the center line of the through hole 8 and the center line of the measuring hole 5 are all vertically provided and are overlapped with each other. The aperture of the passage hole 13 is smaller than that of the through hole 8, and the aperture of the passage hole 13 is smaller than that of the dripping hole 11, which prevents the pipetting head 16 from touching the steam shield 7 and the windshield 10 after extending into the measuring compartment 1, and facilitates the pipetting head 16 to directly drip the liquid at the measuring hole 5 of the measuring compartment 1 after passing through the passage hole 13, the dripping hole 11 and the through hole 8 in sequence, and is beneficial to maintaining the balance and stability of the measuring compartment 1 and ensuring the precision of the liquid weight data measured by the pressure sensor 3.

As a preferred embodiment, as shown in FIG. 1 and FIG. 2, a weighing plate 14 is provided below the measuring compartment 1. The pressure sensor 3 is provided at the middle position directly below the weighing plate 14. A positioning groove 15 is formed in the upper surface of the weighing plate 14. The positioning groove 15 is concave and conical. The positioning groove 15 includes an inner bottom wall provided horizontally and a concave conical surface. An outer bottom wall of the measuring compartment 1 is provided with a positioning portion. The positioning portion is of a convex conical structure. The shape of the positioning portion is matched with the shape of the positioning groove 15 (that is, the positioning portion includes a downward convex conical surface and a horizontal bottom surface below the conical surface). The positioning portion is located in the positioning groove 15. The positioning portion is configured to position the measuring compartment 1 on the weighing plate 14, such that the measuring compartment 1 can be quickly and accurately placed at the designated position on the weighing plate 14, and the balance of the measuring compartment 1 can be ensured. The measuring hole 5 is located at the horizontal bottom surface of the positioning portion, that is, the measuring hole 5 is located directly above the horizontal inner bottom wall of the positioning groove 15. At this time, the sensing end of the temperature sensor 2 is located at the inner bottom wall of the positioning groove 15, such that the center of gravity of the measuring compartment 1 is located directly above the inner bottom wall of the positioning groove 15, which is beneficial to maintaining the balance and stability of the measuring compartment 1 while adding liquid into the measuring compartment 1.

As shown in FIG. 1 and FIG. 2, two Analog-To-Digital Converters 18 (ADCs), a Microcontroller Unit 19 (MCU) and a power module 21 are provided in the shell. One of the analog-to-digital converters 18 is electrically connected with the temperature sensor 2 through a temperature acquisition circuit, and the other the analog-to-digital converters 18 is electrically connected with the pressure sensor 3 through a weighing circuit. Both of the analog-to-digital converters 18 are electrically connected with the microcontroller unit 19, and the microcontroller unit 19 reads the temperature data measured by the temperature sensor 2 and the liquid weight data measured by the pressure sensor 3 through the corresponding one of the analog-to-digital converters 18. The shell is further provided with an external interface 20. The controller 4 transmits power to the external interface 20 through a cable. The power module 21 obtains input power from the external interface 20 and modulates the power into reference power supply AVDD, high-stability differential power supplies VCC+ and VCC−. After the system is started, the controller 4 transmits 5v voltage to the external interface 20 through a connecting cable, and the other modules is supplied power after adjustment and voltage stabilization by the power module 21. After being powered on, the microcontroller unit 19 initializes peripherals and performs system self-test. After the self-test is completed, the system enters the startup state.

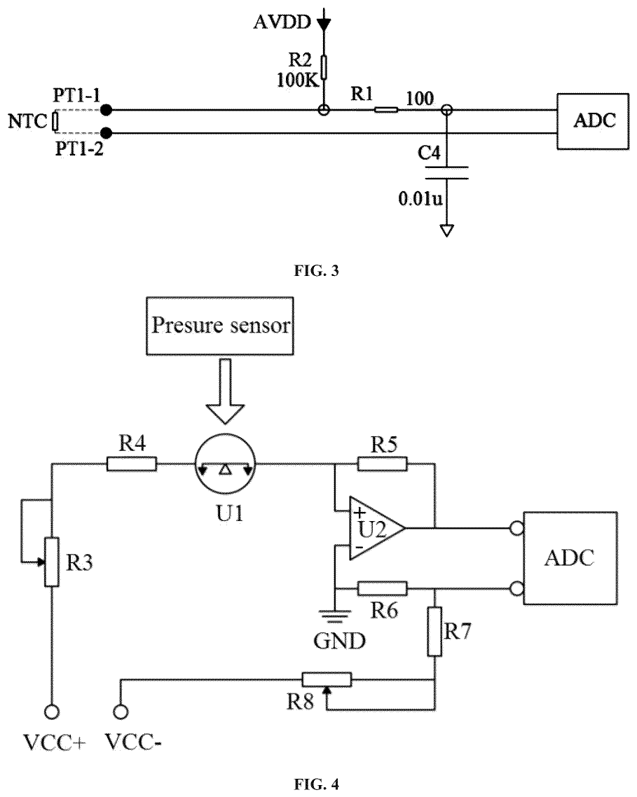

As shown in FIG. 2 and FIG. 3, the temperature acquisition circuit includes a thermistor NTC, a first resistor R1, a second resistor R2 and a capacitor C4. The second resistor R2, the first resistor R1 and the capacitor C4 are connected in series in sequence, one end, far away from the first resistor R1, of the second resistor R2 is connected with the reference power supply AVDD, and one end, far away from the first resistor R1, of the capacitor C4 is grounded. The thermistor NTC is connected in parallel with the first resistor R1 after being communicated with the analog-to-digital converter 18. The reference power supply AVDD acts on the thermistor NTC after being divided by the second resistor R2. The high voltage side of the thermistor NTC is connected with the analog-to-digital converter 18 through the first resistor R1 to achieve signal acquisition and AD conversion, and then the analog-to-digital converter 18 transmits the temperature data to the microcontroller unit 19.

As shown in FIG. 1, FIG. 2 and FIG. 4, the weighing circuit includes a third resistor R3, a fourth resistor R4, an operational amplifier U2, a fifth resistor R5, a sixth resistor R6, a seventh resistor R7 and an eighth resistor R8. The third resistor R3 and the eighth resistor R8 are variable resistors. The operational amplifier U2 is an operational amplifier, as known as Op-Amp. The operational amplifier U2, the fifth resistor R5, the sixth resistor R6 and the seventh resistor R7 form a current-voltage conversion amplification circuit together. The fifth resistor R5 is connected in parallel between the non-inverting input and output of the operational amplifier U2, and the negative input of the operational amplifier U2 is grounded. The current balancer U1 of the pressure sensor 3 is connected with the weighing circuit. One end of the current balancer U1 is connected in series with the fourth resistor R4 and the third resistor R3 (sliding resistor) in sequence. The high-stability differential power supplies VCC+ and VCC− provide a group of high-stability differential power supplies with the same size and opposite phases to the weighing circuit. One end, far away from the fourth resistor R4 of the third resistor R3 is communicated with VCC+. One end, far away from the fourth resistor R4, of the current balancer U1 is electrically connected with the non-inverting input of the operational amplifier U2. The inverting input of the operational amplifier U2 is connected in series with the sixth resistor R6, the seventh resistor R7 and the eighth resistor R8 (sliding resistor). One end, far away from the seventh resistor R7, of the eighth resistor R8 is connected with VCC−. One end of the analog-to-digital converter 18 is electrically connected with the output of the operational amplifier U2, and the other end of the analog-to-digital converter 18 is connected into the line between the sixth resistor R6 and the seventh resistor R7. By adjusting the third resistor R3 and the eighth resistor R8, the current balancer can reach the initial balance. When the measured liquid is added into the measuring compartment 1, the pressure sensor 3 is stressed, and the current balancer U1 outputs a micro-current. The current-voltage conversion amplifier circuit converts the micro-current output by the current balancer U1 into a voltage signal and amplifies the signal. The analog-to-digital converter 18 performs analog-to-digital conversion on the converted and amplified voltage signal and outputs the weight data of the liquid to the microcontroller unit 19. After the liquid is added into the measuring compartment 1 by the pipetting head 16, the microcontroller unit 19 transmits the measurement data to the controller 4 through the data bus. The controller 4 checks and corrects the data, and uploads all the data to an upper computer 17 for recording and storage.

The embodiment further provides a method for calibrating a dynamic ultra-micro pipetting device by using the trace mete, as shown in FIG. 1 to FIG. 4, including the following steps.

In S1, a pipetting head 16 is moved to a target position.

In S2, moving the trace meter is moved to locate a dropping hole 11 directly below the pipetting head 16.

In S3, standard liquid is placed at the position where liquid is to be taken, where the standard liquid adopts a pure water medium;

In S4, the temperature and weight data previously measured by the trace meter is cleared to zero.

In S5, the pipetting head 16 is operated to descend and extends into the measuring compartment, and liquid is dynamically pipetted into the measuring compartment 1 by the same pipetting head 16 for 10 times, and the temperature data and the weight data of the liquid are read after each pipetting by the microcontroller unit 19.

In S6, 10 groups of measurement data in a single channel transmitted by the microcontroller unit 19 is obtained, the 10 groups of measurement data in the single channel are checked and corrected, and the consistency of pipetting of the measurement data in the single channel is calculated by the controller 4;

In S7, standard liquid in the measuring compartment 1 is removed;

In S8, the Step S1 to the Step S7 are repeated to measure the next channel;

In S9, after measuring all channels, the total standard deviation of dynamic high-throughput pipetting is calculated by the controller 4.

In the Step S6 and the Step S9, the controller 4 checks, corrects and calculates the data, and all the data are uploaded to the upper computer for recording and storage.

Further, in the Step S6, the controller 4 checks the temperature data. The temperature

$$t = \frac{{X}_{t} - {X}_{{t}_{0}}}{{R}_{t}} + {t}_{0} ,$$

measurement value is calculated by a formula where t is the temperature measurement value, and to is the temperature measurement lower limit value of the temperature sensor 2 in the unit of ° C.; Xₜ is the output value of the analog-to-digital converter (ADC) 18 at the current temperature; Xₜ₀ is the output value corresponding to the respective analog-to-digital converter at the temperature measurement lower limit value; Rₜ is the resolution of the temperature measuring circuit consisted of the temperature sensor 2 and the analog-to-digital converter, that is, the corresponding change amount of the output data corresponding to the analog-to-digital converter every time there is a change of 1° C.

Further, in the Step S6, the controller 4 checks the weight data, and the weighing value is calculated by the formula

$${m}_{x} = \frac{{X}_{m} - {X}_{{m}_{0}}}{{R}_{m}} + {m}_{0} ,$$

where mx is the mass measurement value, m₀ is the weight measurement lower limit value of the pressure sensor 3 in the unit of μg; Xₘ is the output value of the analog-to-digital converter (ADC) 18 at the current temperature; Xₘ₀ is the output value corresponding to the respective analog-to-digital converter at the temperature measurement lower limit value; Rₘ is the resolution of the weighing circuit consisted of the pressure sensor 3, the corresponding analog-to-digital converter and the weighing circuit, that is, the corresponding change amount of the output data corresponding to the analog-to-digital converter every time there is a change of 1° C.

Further, in the Step S6, the controller 4 checks the liquid volume Vₓ in the measuring compartment 1, where the liquid volume is

$${V}_{x} = \frac{{m}_{x}}{1 + 3 \times {10}^{- 5} t - 6 \times {10}^{- 6} {t}^{2}} ,$$

Vₓ is the liquid volume after each pipetting in the single channel, mx is the mass of the measured liquid, and t is the temperature of the measured liquid. The temperature value input by the operator or the temperature value obtained in Step S5 can be used.

Further, in the Step S6, the controller corrects the liquid volume Vₓ, where the volume correction value is V_{c}=a+b×Vₓ, the measurement result of the corrected volume is V=V_{c}+Vₓ, V is the final measurement result of the liquid volume after the current pipetting, and a and b are the correction coefficients of periodic calibration management and are preset in the controller 4 after the trace meter is measured and calibrated by a calibration unit at an upper level. In this embodiment, the linear fitting method is used to correct the volume in order to reduce the comprehensive error of the liquid volume measurement result of the trace meter. The conventional correction method mostly uses a broken line fitting method, which needs to input standard values and measurement values of all calibration points one by one. It is inconvenient to operate. The linear fitting method is used to correct the volume, which only needs to input two constants, which is simple to operate and stable in correction effect, and is convenient to improve the accuracy of the measurement data of the trace meter.

Further, in the Step S6, the controller 4 calculates the consistency of pipetting in the single channel. The consistency of pipetting in a single channel is

$$γ = \sqrt{\frac{{\sum }_{i = 1}^{n} {( {V}_{i} - \frac{{\sum }_{i = 1}^{n} {V}_{i}}{n} )}^{2}}{n - 1}} ,$$

Vᵢ is the volume of the i-th pipetting in the current channel,

$${V}_{i} = V - {\sum }_{i = 1}^{( i - 1 )} {V}_{i} ,$$

where i=1, 2, 3, . . . , n, n is the total times of pipetting of the current channel. When the single channel performs pipetting for 10 times, n=10.

Further, in the Step S9, the controller 4 calculates the total standard deviation of the dynamic high-throughput pipetting. The total standard deviation of dynamic high-throughput pipetting is

$$σ = \sqrt{\frac{1}{n \times m} {\sum }_{j = 1}^{m} {\sum }_{i = 1}^{n} {( {V}_{ji} - \overline{V} )}^{2}} ,$$

Vⱼᵢ is the volume of the i-th pipetting in a j-th channel, i=1, 2, 3, . . . n, n is the total times of pipetting of the single channel. When the single channel performs pipetting for 10 times, n=10. j=1, 2, 3, . . . m, m is the number of the measured channels, and V̅ is the volume average of each pipetting

$$\overline{V} = \frac{1}{n \times m} {\sum }_{j = 1}^{m} {\sum }_{i = 1}^{n} {V}_{ji} .$$

During each pipetting measurement reading, the system automatically makes ten consecutive readings and calculates the average value. For example, when pipetting in the first channel, the average value of ten consecutive readings is 9.9454 μL≈9.945 μL, and the volume reading data of each pipetting in the first channel is shown in the following table:

the volume of each pipetting (μL)

| V₁ | V₂ | V₃ | V₄ | V₅ | V₆ | V₇ | V₈ | V₉ | V₁₀ |
|---|---|---|---|---|---|---|---|---|---|
| 9.9455 | 9.9454 | 9.9455 | 9.9453 | 9.9453 | 9.9454 | 9.9453 | 9.9454 | 9.9453 | 9.9454 |

According to the formula

$${U}_{A} = \sqrt{\frac{{\sum }_{i = 1}^{n} {( {V}_{i} - \overline{V} )}^{2}}{( n - 1 ) \times n}} ,$$

the average value of the volume of each pipetting is substituted into V in the above formula, and the volume data of each pipetting is substituted into Vᵢ in the above formula. The uncertainty of Class A of the measurement result is calculated as U_{A}=0.08 nL, which is rounded to U_{A}=0.10 nL.

A four-channel dynamic pipetting device is calibrated according to the method of this embodiment, and according to the Step S1 to the Step S8, the measured original data is obtained as follows, where Vᵢ is the volume of each pipetting of the current channel,

$${V}_{i} = V - {\sum }_{i = 1}^{( i - 1 )} {V}_{i} ,$$

and i=1, 2, 3, . . . n. V is the final measurement result of the total liquid volume after the current pipetting.

When calibrating the four channels, the volume of each pipetting is shown in the following table:

| the nominal | | | | | | | | | | | |
|---|---|---|---|---|---|---|---|---|---|---|---|
| value of the | | | | | | | | | | | |
| volume of | | the volume of each pipetting (μL) | | | | | | | | | |
| pipetting | channel | V₁ | V₂ | V₃ | V₄ | V₅ | V₆ | V₇ | V₈ | V₉ | V₁₀ |
| 10 (μL) | 1 | 9.945 | 9.936 | 9.912 | 9.923 | 9.924 | 9.936 | 9.919 | 9.945 | 9.928 | 9.918 |
| | 2 | 9.936 | 9.919 | 9.936 | 9.946 | 9.955 | 9.928 | 9.924 | 9.956 | 9.937 | 9.938 |
| | 3 | 9.953 | 9.960 | 9.946 | 9.952 | 9.935 | 9.963 | 9.954 | 9.960 | 9.934 | 9.952 |
| | 4 | 9.942 | 9.958 | 9.959 | 9.961 | 9.932 | 9.946 | 9.937 | 9.948 | 9.959 | 9.961 |

According to the formula

$$γ = \sqrt{\frac{{\sum }_{i = 1}^{n} {( {V}_{i} - \frac{{\sum }_{i = 1}^{n} {V}_{i}}{n} )}^{2}}{n - 1}} ,$$

the consistency of pipetting in the single channel is calculated, as shown in the following table:

| the nominal | | absolute | relative |
|---|---|---|---|
| value of the | | pipetting | pipetting |
| volume of | | consistency | consistency |
| pipetting (μL) | channel | (μL) | (%) |
| 10 | 1 | 0.0115 | 0.11 |
| | 2 | 0.0122 | 0.12 |
| | 3 | 0.0099 | 0.10 |
| | 4 | 0.0108 | 0.11 |

According to the formula

$$σ = \sqrt{\frac{1}{n \times m} {\sum }_{j = 1}^{m} {\sum }_{i = 1}^{n} {( {V}_{ji} - \overline{V} )}^{2}} ,$$

the absolute total standard deviation of the high-throughput pipetting is calculated as 0.005 μL, and the relative total standard deviation relative to the nominal value of the volume of pipetting is 0.5%.

According to the formula

$$\overline{V} = \frac{1}{n \times m} {\sum }_{j = 1}^{m} {\sum }_{i = 1}^{n} {V}_{ji} ,$$

the average value of the volume of high-throughput pipetting is calculated as V̅=9.942 μL.

According to the indication error=measurement indication value-reference value, the indication error of the high-throughput pipetting device measured this time is calculated as Eₐ=0.058 μL, and the correction value is C=−0.058 μL at the working point of 10 μL.

According to the indication range=maximum positive deviation+maximum negative deviation, the range corrected in this measurement is calculated as R=0.051 μL.

It can be seen that the present disclosure realizes the measurement of precision-related indexes such as the consistency y of pipetting in a single channel, the total standard deviation σ, the indication error Eₐ, and the range R of the trace-level ultra-high-precision and high-throughput pipetting device, and can give the correction value C to calibrate the dynamic pipetting device. The uncertainty of Class A of the measurement result can be up to 1 nL, which is more than one order of magnitude higher than that of the conventional measurement method.

In the solution, according to the method for calibrating the dynamic ultra-micro pipetting device by using the trace meter, the consistency measurement of pipetting in the single channel and the total standard deviation measurement of the high-throughput pipetting device are achieved, such that a high-precision value assurance technology is provided to the high-throughput pipetting device and the pipetting operation, which is beneficial to popularizing the high-throughput metering technology in the high-precision application field. The trace-level ultra-high precision and high-throughput pipetting precision measurement is achieved, in which the volume resolution is up to 0.1 nL and the measurement uncertainty is better than 1 nL which is more than one order of magnitude higher than that of the conventional measurement method. The meaning of the uncertainty refers to the degree that the measured value cannot be affirmed due to the existence of the measurement error. Conversely, the uncertainty also shows the reliability of the result, which is an index of the quality of the measurement result. The smaller the uncertainty, the higher the quality, the higher the level, and the higher its use value. The greater the uncertainty, the lower the quality of the measurement result, the lower the level, and the lower its use value. When reporting the measurement result of physical quantities, the corresponding uncertainty must be given, which is convenient for users to evaluate their reliability on the one hand and enhances the comparability of the measurement results on the other hand. The automatic calibration of pipetting precision of the pipetting device is achieved, which greatly improves the calibration efficiency of the pipetting device.

The above-mentioned specific embodiments further explain the purpose, the technical solution and the beneficial effect of the present disclosure in detail. It should be understood that the above-mentioned embodiments are only specific embodiments of the present disclosure and are not used to limit the scope of protection of the present disclosure. Any modification, equivalent substitution, improvement, etc. made within the spirit and principle of the present disclosure should be included in the scope of protection of the present disclosure.

What is claimed is:

1. A trace meter, comprising a measuring compartment (1), a temperature sensor (2), a pressure sensor (3) and a controller (4), wherein a top of the measuring compartment (1) is open, the temperature sensor (2) is provided at a bottom of the measuring compartment (1), the pressure sensor (3) is provided below the measuring compartment (1), both the temperature sensor (2) and the pressure sensor (3) are electrically connected with the controller (4), the temperature sensor (2) is configured to measure a temperature of liquid in the measuring compartment (1), and the pressure sensor (3) is configured to measure a weight of the liquid in the measuring compartment (1).

2. The trace meter according to claim 1, wherein an inner bottom wall of the measuring compartment (1) is provided with a lowest inclination point, the lowest inclination point is located directly below a center of gravity of the measuring compartment (1), a measuring hole (5) is formed at the lowest inclination point of the bottom wall of the measuring compartment (1), one side, adjacent to an inside of the measuring compartment (1), of the measuring hole (5) is covered with a flexible heat-conducting film (6), and a sensing end of the temperature sensor (2) is placed in the measuring hole (5) and abuts against a lower surface of the flexible heat-conducting film (6).

3. The trace meter according to claim 1, wherein a steam shield (7) covers above the measuring compartment (1), and a through hole (8) is formed in the steam shield (7) for a pipetting head (16) to pass through.

4. The trace meter according to claim 3, further comprising a bottom shell (9) provided below the measuring compartment (1), wherein the pressure sensor (3) is provided in the bottom shell (9), the bottom shell (9) is provided with a windshield (10), the windshield (10) is configured to cover the measuring compartment (1), a dripping hole (11) is formed in a top wall of the windshield (10) for the pipetting head (16) to pass through, a protective plate (12) is provided above the windshield (10), a passage hole (13) is formed in the protective plate (12), an aperture of the through hole (8) and an aperture of the dripping hole (11) are both larger than an aperture of the passage hole (13), a center line of the dripping hole (11), a center line of the through hole (8) and a center line of the measuring hole (5) are overlapped with each other, and gaps are left between the measuring compartment (1) and the windshield (10) and between the steam shield (7) and the windshield (10), respectively.

5. The trace meter according to claim 1, wherein a weighing plate (14) is provided below the measuring compartment (1), the pressure sensor (3) is located below the weighing plate (14), a positioning groove (15) is formed in the weighing plate (14), the positioning groove (15) comprises a concave conical surface and a horizontal inner bottom wall, an outer bottom wall of the measuring compartment (1) is provided with a positioning portion, a shape of the positioning portion is matched with a shape of the positioning groove (15), the positioning portion is located in the positioning groove (15), and the measuring hole (5) of the measuring compartment (1) is located directly above the horizontal inner bottom wall of the positioning groove (15).

6. A method for calibrating a dynamic ultra-micro pipetting device, wherein the method calibrates the dynamic ultra-micro pipetting device by using the trace meter according to claim 1, the method comprises following steps:
S1, moving a pipetting head to a target position;
S2, moving the trace meter to locate a dripping hole directly below the pipetting head;
S3, placing standard liquid at a position where liquid is to be taken;
S4, clearing measurement data of the trace meter to zero;
S5, operating a same pipetting head to dynamically pipet liquid into a measuring compartment for n times, and reading a temperature data and a weight data of the liquid after each pipetting, wherein n is total pipetting times in a single channel;
S6, obtaining n groups of measurement data of the dynamic pipetting process in the single channel, checking and correcting the measurement data, and calculating consistency of pipetting in the single channel by the controller;
S7, removing the standard liquid in the measuring compartment;
S8, repeating Step S1 to Step S7 to measure a next channel;
S9, after measuring all channels, calculating a total standard deviation of dynamic high-throughput pipetting.

7. The method for calibrating the dynamic ultra-micro pipetting device according to claim 6, wherein in the Step S6, the controller calculates a liquid volume in the measuring compartment, wherein the liquid volume is
$${V}_{x} = \frac{{m}_{x}}{1 + 3 \times {10}^{- 5} t - 6 \times {10}^{- 6} {t}^{2}} ,$$
Vₓ is the liquid volume after each pipetting in the single channel, mx is a mass of a measured liquid, and t is a temperature of the measured liquid.

8. The method for calibrating the dynamic ultra-micro pipetting device according to claim 7, wherein in the Step S6, the controller corrects the liquid volume Vₓ, wherein a volume correction value is V_{c}=a+b×Vₓ, a measurement result of a corrected volume is V=Vc+Vₓ, V is a final measurement result of the liquid volume after current pipetting, and a and b are correction coefficients of periodic calibration management and are preset in the controller after being measured and calibrated by a calibration unit at an upper level.

9. The method for calibrating the dynamic ultra-micro pipetting device according to claim 8, wherein in the Step S6, the consistency of pipetting in the single channel is
$$γ = \sqrt{\frac{{\sum }_{i = 1}^{n} {( {V}_{i} - \frac{{\sum }_{i = 1}^{n} {V}_{i}}{n} )}^{2}}{n - 1}} ,$$
Vᵢ is a volume of i-th pipetting in a current channel,
$${V}_{i} = V - {\sum }_{i = 1}^{( i - 1 )} {V}_{i} ,$$
wherein i=1, 2, 3, . . . n.

10. The method for calibrating the dynamic ultra-micro pipetting device according to claim 9, wherein in the Step S9, the total standard deviation of the dynamic high-throughput pipetting is
$$σ = \sqrt{\frac{1}{n \times m} {\sum }_{j = 1}^{m} {\sum }_{i = 1}^{n} {( {V}_{ji} - \overline{V} )}^{2}} ,$$
Vᵢⱼ is the volume of the i-th pipetting in a j-th channel, i=1, 2, 3, . . . n, j=1, 2, 3, . . . m, m is a number of measured channels, and V̅ is a volume average of each pipetting,
$$\overline{V} = \frac{1}{n \times m} {\sum }_{j = 1}^{m} {\sum }_{i = 1}^{n} {V}_{ji} .$$

11. The method for calibrating the dynamic ultra-micro pipetting device according to claim 6, wherein an inner bottom wall of the measuring compartment (1) is provided with a lowest inclination point, the lowest inclination point is located directly below a center of gravity of the measuring compartment (1), a measuring hole (5) is formed at the lowest inclination point of the bottom wall of the measuring compartment (1), one side, adjacent to an inside of the measuring compartment (1), of the measuring hole (5) is covered with a flexible heat-conducting film (6), and a sensing end of the temperature sensor (2) is placed in the measuring hole (5) and abuts against a lower surface of the flexible heat-conducting film (6).

12. The method for calibrating the dynamic ultra-micro pipetting device according to claim 6, wherein a steam shield (7) covers above the measuring compartment (1), and a through hole (8) is formed in the steam shield (7) for a pipetting head (16) to pass through.

13. The method for calibrating the dynamic ultra-micro pipetting device according to claim 12, wherein the trace meter further comprises a bottom shell (9) provided below the measuring compartment (1), the pressure sensor (3) is provided in the bottom shell (9), the bottom shell (9) is provided with a windshield (10), the windshield (10) is configured to cover the measuring compartment (1), a dripping hole (11) is formed in a top wall of the windshield (10) for the pipetting head (16) to pass through, a protective plate (12) is provided above the windshield (10), a passage hole (13) is formed in the protective plate (12), an aperture of the through hole (8) and an aperture of the dripping hole (11) are both larger than an aperture of the passage hole (13), a center line of the dripping hole (11), a center line of the through hole (8) and a center line of the measuring hole (5) are overlapped with each other, and gaps are left between the measuring compartment (1) and the windshield (10) and between the steam shield (7) and the windshield (10), respectively.

14. The method for calibrating the dynamic ultra-micro pipetting device according to claim 6, wherein a weighing plate (14) is provided below the measuring compartment (1), the pressure sensor (3) is located below the weighing plate (14), a positioning groove (15) is formed in the weighing plate (14), the positioning groove (15) comprises a concave conical surface and a horizontal inner bottom wall, an outer bottom wall of the measuring compartment (1) is provided with a positioning portion, a shape of the positioning portion is matched with a shape of the positioning groove (15), the positioning portion is located in the positioning groove (15), and the measuring hole (5) of the measuring compartment (1) is located directly above the horizontal inner bottom wall of the positioning groove (15).
